(19) United States
(12) Patent Application Publication
(10) Pub. No.: US 2023/0052981 A1
(43) Pub. Date: Feb. 16, 2023

(54) AUTOMATIC INDUCTION HEATING PET MAT

(71) Applicant: Jiangsu Fangxiangji Textile Technology Co., Ltd., Yancheng (CN)

(72) Inventors: HAIFENG WU, Yancheng (CN); JIANGANG DUAN, Yancheng (CN)

(21) Appl. No.: 17/647,451

(22) Filed: Jan. 8, 2022

(30) Foreign Application Priority Data
Aug. 14, 2021 (CN) 202121910805.1

(51) Int. Cl. A01K 1/015; A01K 29/00

(52) U.S. Cl. CPC A01K 1/0158; A01K 1/0157; A01K 29/005

(57) ABSTRACT

An automatic induction heating pet mat includes a pet mat body, a control switch, a pressure device, a temperature controller, a control chip, and a heating device. The pressure device, the temperature controller, the control chip and the heating device are arranged inside the pet mat body. One end of the control switch is coupled to an external power supply through a power cord, and another end of the control switch is coupled to the control chip through a wire. The control chip is electrically connected to each of the pressure device, the temperature controller, the control chip, and the heating device. The pressure device is a pressure sensor and has a pressure range of 0.5-80 KG.

### CROSS-REFERENCE TO RELATED APPLICATIONS

This application claims the benefit and priority of Chinese patent application No. 202121910805.1, filed on Aug. 14, 2021, disclosure of which is hereby incorporated by reference in its entirety.

### TECHNICAL FIELD

The present application relates to the technical field of pet mats, and more particularly relates to an automatic induction heating pet mat.

### BACKGROUND

As the society is developing and science continues to advance, people’s lives become increasingly colorful and many people keep small pets in company for a better family atmosphere. Pets are our close companions and loyal friends, and they are always by our side like family, meeting the emotional needs of our hearts.

As pet mats are essential daily necessities for pets, existing pet mats often do not have a heating function. In the cold winter, pets can only rely on their own fur to resist the cold. Therefore, it is necessary for us to design a pet mat with heating function. However, in the related art, heating wires are usually used for heating. Long-term heating can easily cause damage to the heating wires and pet pads, and even cause fires. Therefore, it is necessary to control the heating of the pet pads.

Therefore, an automatic induction heating pet mat is urgently needed in the market to solve this problem.

### SUMMARY

In view of the deficiencies in the related art, the present application proposes an automatic induction heating pet mat. The design according to the present application is reasonable, its structure is novel and convenient to disassemble and assemble, and it is convenient to use. It can realize the functions of heating, keeping warm and waterproof and is comfortable and soft. It is especially suitable for warming pets in cold weather in winter, and has strong practicability.

In order to achieve the above objectives, the present application adopts the following technical solutions:

An automatic induction heating pet mat, wherein comprising: a pet mat body, a control switch, a pressure device, a temperature controller, a control chip and a heating device, wherein the pressure device, the temperature controller, the control chip and the heating device are arranged inside the pet mat body, one end of the control switch is connected to the external power supply through a power cord, and the other end of the control switch is connected to the control chip through a wire, wherein the control chip is electrically connected to the pressure device, the temperature controller, the control chip and the heating device, respectively, the pressure device is a pressure sensor, and the pressure range of the pressure sensor is 0.5-80 KG, wherein the pressure sensor converts a pressure signal into an electric signal and transmits it to the control chip, and then the control chip transmits the corresponding electric signal to the temperature controller according to the pressure, and then the temperature controller transmits the corresponding electric signal to the heating device, and finally the heating device heats the pet mat body at a specified temperature according to the electrical signal.

As a further explanation of the above technical solution:

In the above technical solution, the pet mat body comprises a seat cushion and an outer cover, one side of the outer cover is provided with an opening, and the seat cushion enters the interior of the outer cover through the opening, a supporting mat is arranged on the seat cushion, the pressure device, the temperature controller, the control chip, and the heating device are arranged on the supporting mat and located inside the outer cover.

In the above technical solution, the heating device is a heating net, and the heating net is attached to the supporting mat.

In the above technical solution, the outer cover is made of wool or super soft cloth, the outer surface of the outer cover is provided with a waterproof layer, and the seat cushion is a water-permeable sponge.

In the above technical solution, the outside of the power cord is covered with a waterproof and anti-bite rubber sleeve.

In the above technical solution, an indicator lamp is provided on the control switch, and the indicator lamp is used to identify whether the heating device is working normally.

In the above technical solution, a receiving portion for a mobile power supply is provided inside the outer cover, the mobile power supply is a battery or a power bank, and the mobile power supply is electrically connected to the control switch through the power cord, and the receiving portion for a mobile power supply is used for receiving the battery or the power bank, and the battery or power bank is used to provide electrical energy for the pressure device, the temperature controller, the control chip and the heating device.

In the above technical solution, the heating temperature range of the heating net is 35-60° C.

Compared with the related art, the present application has obvious advantages and beneficial effects. Specifically, the structure is novel and the design is reasonable. The pressure value is transmitted to the control chip through the pressure device, and the data is transmitted to the temperature controller through the control chip. After the temperature controller compares the real-time data with the preset data, it controls the heating device to heat at a specified temperature without manual intervention. After the pet pad feels the pressure, it can be heated at a reasonable temperature according to the pet’s gravity to make the pet’s living environment more comfortable. The pet mat has an exquisite appearance and the seat cushion is soft and comfortable. By using mobile power, pet mats can be used indoors and outdoors. When there is no fixed power source, you can use batteries or power banks for heating. When the pet leaves, the pressure device cannot feel the pressure, and the heating device of the pet mat automatically cuts off the power to stop heating. It has high safety, energy saving and environmental protection, and is especially suitable for pets to resist the cold in winter and has strong practicability.

In order to more clearly illustrate the structural features, technical means, and specific objectives and functions achieved by the present application, the following further describes the present application in detail with reference to the drawings and specific embodiments:

### BRIEF DESCRIPTION OF DRAWINGS

The attached the FIGURE is a schematic diagram of the structure of the present application.

### DETAILED DESCRIPTION OF ILLUSTRATIVE EMBODIMENTS

In the description of the present application, it should be noted that the terms “center”, “upper”, “lower”, “left”, “right”, “vertical”, “horizontal”, “inner”, “outer”, etc. which are used to indicate position or positional relationship are based on the position or positional relationship shown in the drawings, and are only for the convenience of describing the application and simplifying the description, rather than indicating or implying that the indicated position or element must have a specific orientation and be constructed in a specific orientation and operation, therefore cannot be understood as a limitation of the present application.

In the description of the present application, it should be noted that unless otherwise clearly specified and limited, the terms “installation”, and “connection” should be understood in a broad sense, for example, it can be a fixed connection or a detachable connection, or integrally connected; it can be a mechanical connection or an electrical connection; it can be directly connected, or indirectly connected through an intermediate medium, and it can be the internal communication between two components. For those skilled in the art, the specific meaning of the above-mentioned terms in the present application can be understood according to the specific circumstances.

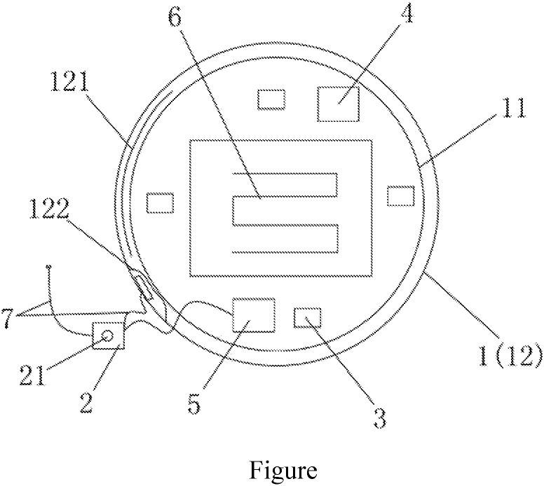

An automatic induction heating pet mat as shown in FIG. 1, comprises a pet mat body 1, a control switch 2, a pressure device 3, a temperature controller 4, a control chip 5 and a heating device 6, wherein the pressure device 3, the temperature controller 4, the control chip 5 and the heating device 6 are arranged inside the pet mat body 1, one end of the control switch 2 is connected to the external power supply through a power cord 7, and the other end of the control switch 2 is connected to the control chip 5 through a wire, wherein the control chip 5 is electrically connected to the pressure device 3, the temperature controller 4, the control chip 5 and the heating device 6, respectively. The pressure device 3 is a pressure sensor, and the pressure range of the pressure sensor is 0.5-80 KG. The pressure sensor 3 converts a pressure signal into an electric signal and transmits it to the control chip 5, and then the control chip 5 transmits the corresponding electric signal to the temperature controller 4 according to the pressure, and then the temperature controller 4 transmits the corresponding electric signal to the heating device 6, and finally the heating device 6 heats the pet mat body 1 at a specified temperature according to the electrical signal.

As a further improvement of the present application, the pet mat body 1 comprises a seat cushion 11 and an outer cover 12. One side of the outer cover 12 is provided with an opening 121, and the seat cushion 11 enters the interior of the outer cover 12 through the opening. A supporting mat is arranged on the seat cushion 11, and the pressure device 3, the temperature controller 4, the control chip 5, and the heating device 6 are arranged on the supporting mat and located inside the outer cover 11.

As a further improvement of the present application, the heating device 6 is a heating net, and the heating net is attached to the supporting mat.

As a further improvement of the present application, the outer cover 12 is made of wool or super soft cloth, the outer surface of the outer cover 12 is provided with a waterproof layer, and the seat cushion 11 is a water-permeable sponge.

As a further improvement of the present application, the outside of the power cord 7 is covered with a waterproof and anti-bite rubber sleeve.

As a further improvement of the present application, an indicator lamp 21 is provided on the control switch 2, and the indicator lamp 21 is used to identify whether the heating device 6 is working normally.

As a further improvement of the present application, a receiving portion 122 for a mobile power supply is provided inside the outer cover 12, the mobile power supply is a battery or a power bank, and the mobile power supply is electrically connected to a control switch 2 through the power cord 7, and the receiving portion for a mobile power supply is used for receiving the battery or the power bank, and the battery or power bank is used to provide electrical energy for the pressure device 3, the temperature controller 4, the control chip 5 and the heating device 6.

The above are only the illustrative embodiments of the present application and are not intended to limit the application. Therefore, any modification, equivalent replacement, improvement, etc., made to the above embodiments based on the actual technology of the present application still fall within the scope of the technical solution of the present application.

What is claimed is:

1. An automatic induction heating pet mat, comprising: a pet mat body, a control switch, a pressure device, a temperature controller, a control chip, and a heating device, wherein the pressure device, the temperature controller, the control chip and the heating device are arranged inside the pet mat body, one end of the control switch is coupled to an external power supply through a power cord, and another end of the control switch is coupled to the control chip through a wire, wherein the control chip is electrically connected to each of the pressure device, the temperature controller, the control chip, and the heating device, , wherein the pressure device is a pressure sensor, and a pressure range of the pressure sensor is 0.5-80 KG, wherein the pressure sensor is configured to convert a pressure signal into an electric signal and transmit the pressure signal to the control chip, and then the control chip is configured to transmit the electric signal corresponding to the pressure to the temperature controller, and then the temperature controller is configured to transmit the corresponding electric signal to the heating device, and finally the heating device is configured to heat the pet mat body to a specified temperature according to the electrical signal.

2. The automatic induction heating pet mat as recited in claim 1, wherein the pet mat body comprises a seat cushion and an outer cover, one side of the outer cover defines an opening, and the seat cushion enters an interior of the outer cover through the opening, a supporting mat is arranged on the seat cushion, wherein the pressure device, the temperature controller, the control chip, and the heating device are arranged on the supporting mat and disposed inside the outer cover.

3. The automatic induction heating pet mat as recited in claim 2, wherein the heating device is a heating net, which is attached to the supporting mat.

4. The automatic induction heating pet mat as recited claim 2, wherein the outer cover is made of wool or super soft cloth, an outer surface of the outer cover is provided with a waterproof layer, and the seat cushion is a water-permeable sponge.

5. The automatic induction heating pet mat as recited in claim 1, wherein an exterior of the power cord is covered with a waterproof and anti-bite rubber sleeve.

6. The automatic induction heating pet mat as recited in claim 1, wherein an indicator lamp is arranged on the control switch and is configured to identify whether the heating device is operating normally.

7. The automatic induction heating pet mat as recited in claim 2, wherein a receiving portion for receiving a mobile power supply is disposed inside the outer cover, wherein the mobile power supply is a battery or a power bank and is electrically connected to a control switch through the power cord, and wherein the receiving portion for receiving the mobile power supply is configured for receiving the battery or the power bank, and the battery or power bank is configured to provide electrical energy for the pressure device, the temperature controller, the control chip and the heating device.

8. The automatic induction heating pet mat as recited in claim 3, wherein a heating temperature range of the heating net is 35-60° C.
